(19) United States
(12) Patent Application Publication
(10) Pub. No.: US 2014/0263754 A1
(43) Pub. Date: Sep. 18, 2014

(54) MULTIPLE ORIFICE PRESSURE WASHER NOZZLE ASSEMBLIES

(71) Applicant: Generac Power Systems, Inc., Waukesha, WI (US)

(72) Inventors: Peter Nushart, Waukesha, WI (US); Kevin Rachuk, Harvard, IL (US); Mir Kahn, Kenosha, WI (US)

(21) Appl. No.: 13/842,486

(22) Filed: Mar. 15, 2013

(51) Int. Cl. B05B 1/16

(52) U.S. Cl. CPC B05B 1/16
USPC 239/442

(57) ABSTRACT

Pressure washer nozzle assemblies that include multiple orifices that each generate a respective spray pattern or are suitable for alternate applications. The nozzle assemblies include a flow body that is constructed to be associated with a wand and a control or controller that is movably associated with the flow body. Manipulation of the controller relative to the flow body effectuates different flow configurations that are each associated with selectively fluidly connecting alternate orifices associated with the nozzle assembly with the fluid flow delivered via the wand.

### FIELD OF THE INVENTION

The present invention relates generally to pressure washer systems, and in particular, to pressure washer wand and nozzle assemblies that can be configured to provide various spray patterns without dissociation or removal of the nozzle assembly from the wand.

### BACKGROUND OF THE INVENTION

Pressure washers generally include a motor or engine that is operatively connected to a water pump. A high pressure hose connects a wand to a discharge side of the water pump. The wand commonly includes a pistol grip or the like that includes a trigger whose actuation effects discharge of a high-pressure water stream from the nozzle. Both the simplicity of operation and effectiveness associated with using such devices has made pressure washers a staple for various residential and commercial cleaning and surface preparation tasks.

Understandably, many cleaning and surface preparation operations are best carried out with the use of extraneous cleaning or surface treatment agents and/or manipulation of the spray pattern associated with operation of the pressure washer. For instance, some surface cleaning or preparation activities are more easily performed with a more centralized or unitary stream of water whereas other cleaning or surface preparation operations can be best performed with a fan or cone spray stream wherein the water stream is aligned along an axis or emanates from the wand in a more conical shape, respectively. To better effectuate the desired cleaning or surface preparation operations, many power washers are configured for use with interchangeable or replaceable nozzles that are each configured to removably cooperate with the discharge end of the wand. Such systems commonly require that a number of discrete nozzle assemblies be provided and maintained to generate the desired spray pattern. The relatively small size of such interchangeable nozzles renders them susceptible to being dropped, lost, or misplacement thereby requiring the user to replace lost or misplaced nozzles if the spray pattern associated with the nozzle is needed for a desired cleaning or treatment operation.

Recognizing such a shortcoming, others provide adjustable nozzle assemblies that can be constructed to cooperate with the discharge end of a wand. Such nozzle assemblies can be configured to removably cooperate with the wand in a tool-less manner or be configured to more rigidly cooperate with the wand such that one or more tools are required to manipulate cooperation of the nozzle assembly with the wand. Many such adjustable nozzle assemblies include a control or dial that is associated with the nozzle assembly. The control or dial is commonly configured to be rotatable about an axis that is perpendicular to or normal to the direction of the fluid flow. Other adjustable spray nozzle assemblies include a plurality of discrete nozzles orifices that each has unique shapes associated with generating a desired spray pattern when the respective orifice is aligned with the fluid flow through the wand. Such adjustable spray pattern nozzle assemblies can suffer from a number of drawbacks.

Such nozzle assemblies must commonly be provided with a number of seals that prevent water from being allowed to exit the nozzle assembly at undesired or unused orifices or along paths associated with the interface of the control with the fluid path or a support portion of the nozzle assembly. Such nozzle assemblies must also commonly include fairly tight manufacturing tolerances between the parts of the nozzle assembly that are intended to be moveable and require the formation of various parts of materials that are capable of withstanding the operating conditions associated with discrete interchangeable use of the respective orifices associated with the respective nozzle assembly.

Some such nozzle assemblies are also generally considerably larger than nozzles having only a singular orifice. That is, the various orifice openings are commonly circumferentially positioned about a rotational control body so that only one respective orifice is aligned with the fluid passage associated with the wand at any given time. The unused orifice openings are generally circumferentially spaced relative to an axis of rotation of the control body so that each discrete orifice can be selectively aligned with an in-use position of the orifice relative to the underlying nozzle assembly. The circumferential spacing of the various orifices dramatically increases the footprint or size of the overall nozzle assembly. Such constructions can limit the ability of the user to attain a desired position of the nozzle relative to a treatment surface where frame or other structural considers limit the accessibility of the area being treated.

Therefore, there is a need for a pressure washer wand and nozzle assembly capable of providing various spray patterns that is convenient to manufacture and use, has reliable operability, and has a compact construction.

### SUMMARY OF THE INVENTION

The present invention discloses various nozzle assemblies for use with pressure washing systems that each overcome one or more of the drawbacks mentioned above. One aspect of the invention discloses pressure washer nozzle assemblies that each include multiple orifices that each generate a respective spray pattern. Each nozzle assembly includes a flow body that is constructed to be associated with a wand and a control or controller that is movably associated with the flow body. Manipulation of the controller relative to the flow body effectuates different flow configurations that are each associated with selectively and discretely fluidly connecting the alternate orifices associated with the nozzle assembly with the fluid flow delivered via the wand such that the user can manipulate a spray pattern delivered by the power washer via interaction with rather than replacement of a respective nozzle assembly previously associated with a wand.

One aspect of the invention discloses a pressure washer nozzle assembly having a flow body that is constructed to be fluidly connected to a discharge end of a wand. The nozzle assembly includes a first orifice and a second orifice that are exposed to atmosphere and supported by the flow body such that the first orifice and the second orifice are each selectively fluidly connectable to a fluid path defined by the flow body. The nozzle assembly includes a control body that is rotationally associated with the flow body. A shuttle is supported by the flow body and engaged with the control body such that rotation of the control body effectuates longitudinal translation of the shuttle relative to the flow body to selectively fluidly connect the first orifice and the second orifice to the fluid path defined by the flow body.

Another aspect of the invention discloses a pressure washer nozzle assembly having a flow body that defines a flow body fluid path constructed to receive a fluid flow from a discharge end of a wand. A controller is engaged with the flow body and defines a first discharge fluid path associated with a first orifice and a second discharge fluid path associated with a second orifice. The first and second orifices are radially offset from an axis of the flow body and the controller is axially slidable relative to the flow body to selectively fluidly connect the first discharge fluid path and the second discharge fluid path to the flow body fluid path.

Another aspect of the invention discloses a pressure washer nozzle assembly that includes a flow body that is constructed to be secured to a discharge end of a wand and defines a flow body flow path that is formed through the flow body. The nozzle assembly includes a controller that is engaged with a pivot that is defined by the flow body such that the controller is rotatable relative to the flow body. A first orifice and a second orifice associated with the controller and radially offset from an axis of rotation of the controller and the controller is rotatable about the pivot between a first position and a second position. When in the first portion, the controller and flow body cooperate with one another such that first orifice is fluidly connected from the flow body flow path and the second orifice is positionally offset from the flow body flow path. When in the second position, the controller and flow body cooperate with one another such that the first orifice is positionally offset from the flow body flow path and the second orifice is fluidly connected to the flow body flow path such that the first and second orifices can be selectively and discretely associated with a fluid path associated with the discharge end of the wand.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a portable engine powered pressure washing device equipped with a variable spray pattern nozzle assembly according to the present invention;

FIG. 2 is a detailed perspective view of a nozzle assembly usable with the pressure washer shown in FIG. 1;

FIG. 3 is cross section elevation view of the nozzle assembly shown in FIG. 2;

FIG. 4 is a perspective view of a nozzle assembly according to another embodiment of the present invention;

FIG. 5 is a view similar to FIG. 4 and shows a cross section of the nozzle assembly shown therein;

FIG. 6 is a detailed view of the cross section of the nozzle assembly shown in FIG. 5 taken along line 6-6 and shows a controller in a first position relative to a flow body of the nozzle assembly;

FIG. 7 is a view similar to FIG. 6 and shows the controller in a second axial position relative to the flow body;

FIG. 8 is a perspective view of a wand equipped with a nozzle assembly according to another embodiment of the present invention;

FIG. 9 is a detailed view of the nozzle assembly shown in FIG. 8 with a controller in a partial sectional view exposing the flow body;

FIG. 10 is an end perspective view of the nozzle assembly shown in FIG. 8;

FIG. 11 is a view similar to FIG. 10 with a cover removed from the controller of the nozzle assembly;

FIG. 12 is a perspective view of an underside of the cover of the controller of the nozzle assembly shown in FIG. 10; and

FIG. 13 is a cross-section view of the nozzle assembly shown in FIG. 10 along line 13-13.

### DETAILED DESCRIPTION OF THE DRAWINGS

FIG. 1 shows a portable engine powered pressure washer 40 that is constructed to cooperate with one or more of the variable orifice nozzle assemblies 52 according to one or more of the embodiments of the present invention as disclosed herein. As shown in FIG. 1, pressure washer 40 includes an internal combustion engine 42 that is operationally connected to a pump 44. It is appreciated that the nozzle assemblies according to the present invention are usable with many underlying power or pressure washer systems, including those having an engine or a motor driven pump as well as less portable pressure washing systems. Those skilled in the art will readily appreciate the various alternative configurations of a power washing system usable with one or more of the nozzle assemblies according to the present application.

With respect to pressure washer 40, engine 42 can be directly or indirectly (via a power transmission system such as a belt or other flexible drive member) coupled to pump 44. When engine 42 directly cooperates with pump 44 without supplemental power transmission systems, pump 44 can be considered a direct drive pump. It is appreciated that there a number of methodologies associated with generating a desired fluid pressure output associated with use of pressure washer 40. One methodology includes providing a pressure output of the pump that is a function of the operational revolutions per minute (rpm) of the pump and which is directly correlated to the operating speed or revolutions per minute (rpm) of the engine crankshaft. The higher the rpm of the pump, the higher the pump output pressure—assuming other system variables to be constant. In such a confirmation, the input rpm of the pump is controlled by the engine rpm by means of controlling the engine throttle such that, variable pressures can be provided at the pump output pressure via manipulation of the engine throttle or engine speed. Alternatively, it is appreciated that the pressure output of pump 44 may be manipulated by a regulator as disclosed below. The variable pressure pump output in conjunction with an engine speed or pump pressure selector dial allows one pressure washer to act as though it were capable of providing several different fixed operating pressures.

As alluded to above, another methodology for manipulating the pump discharge pressure delivered to the wand includes providing a variable setting regulator or bypass valve assembly 47 associated with operation of the pump. Such a configuration includes a valve assembly that is integral to the pump or disposed between pump 44 and a wand 46 for communicating the pressurized fluid flow to wand 46 connected to pump 44. A hose 48 is configured to be connected between pump 44 and a wand 46 to communicate the pressurized flow generated by operation of pressure washer 40 to the nozzle assembly associate with a discharge end 50 of wand 46.

Still referring to FIG. 1, wand 46 is connected to an output side of pump 44 via hose 48 such that actuation of a trigger 53 associated with wand 46 effectuates discharge of the pressurized flow from wand 46 via nozzle assembly 52. Trigger 53 is associated with an operator end 62 of wand 46 that is generally offset from discharge end 50 of wand 46. Pressure washer 40 preferably includes a chassis 54 having one or more wheels 56 and a handle 60 for improving the mobility of the unit and to facilitate convenient transportation of pressure washer 40. It is appreciated that the nozzle assemblies disclosed herein are usable with other less mobile pressure washing systems.

Discharge end 50 of wand 46 is commonly associated with an end of wand 46 that is opposite trigger 53. Discharge end 50 of wand 46 is constructed to cooperate with nozzle assembly 52 to allow the fluid flow communicated via wand 46 to be directed through nozzle assembly 52. Nozzle assembly 52 can be configured to removably cooperate with wand 46 via one or more threaded or otherwise selectively severable connection methodologies that can either provide a tool-less interaction or a tool operable interaction between nozzle assembly 52 and wand 46. It is appreciated that various such tool requiring and tool-less interactions are feasible as both provide a secure connection between a respective nozzle assembly 52 and wand 46.

Although each of the nozzle assemblies disclosed herein is preferably configured to provide at least two discrete spray patterns, it is further appreciated that pressure washer 40 can be provided with and is usable with other alternate or replacement nozzles or nozzle assemblies that can be engaged with wand 46 when nozzle assembly 52 is removed therefrom. Preferably, such replacement nozzle assemblies cooperate with wand 46 in the same manner as nozzle assembly 52 and are configured to provide spray patterns and/or soaping and/or foaming functions associated with alternate uses of pressure washer 40. As explained further below, nozzle assembly 52 is configured to provide various spray patterns but it is appreciated that pressure washer 40 may have an operating range that extends beyond a range of operation associated with use of any one multiple spray pattern nozzle assembly 52. It is appreciated that nozzle assembly 52 can be configured to cooperate with wand 46 in a tool-less manner or in a manner that would require one or more tools to effectuate separation of nozzle assembly 52 from wand 46 as explained above for alternate uses of pressure washer 40 or use of pressure washer 40 with nozzles or nozzle assemblies having other functionality.

Pressure washer 40 can include a panel, bezel, or dashboard 61 that can include one or more instructional indicia 64 associated with the desired operation or intended use of pressure washer 40. Preferably, dashboard 61 includes one or more indicia that explain, either textually or pictographically, proper operation of pressure washer 40. It is also appreciated that dashboard 61 can include one or more receptacles or mounting portions 66 associated with supporting replaceable or interchangeable tips, nozzles, or nozzle assemblies 72, 74, 76, 78, 80 associated with alternate uses of pressure washer 40 beyond the operating capabilities of nozzle assembly 52 and/or a replacement nozzle assembly 52 should the in-use nozzle assembly be somehow rendered inoperable. Preferably, aside from foaming operations, nozzle assembly 52 is configured to provide alternate spray patterns across the range of operation of pressure washer 40. As alluded to above, nozzles 72-80 are configured to interchangeably cooperate with discharge end 50 of wand 46 so as to replace nozzle assembly 52 thereby allowing use of pressure washer 40 for other uses, such as soap, foaming, cleaning, or treatment agent application operations.

It is also appreciated that one more of nozzles 72, 74, 76, 78, 80 could have a construction similar to—but preferably different than—nozzle assembly 52. It is envisioned that such a nozzle assembly and/or the providing of more than one nozzle assembly capable of generating various spray patterns would provide a pressure washer system with nozzles capable of providing multiple spray patterns that are different than the spray patterns associated with nozzle assembly already engaged with wand 46. Such a provision would provide a pressure washing system capable of providing a greater range of adjustment of the spray pattern as a function of an association of a given multiple spray pattern nozzle assembly as it relates to a range of operation of the underlying pressure washer 40 as well as the singular or multiple spray patterns achievable with other nozzle assemblies.

It is further appreciated that wand 46 or pressure washer 40 can include a treatment agent introduction system 86 for introducing a cleaning or treatment agent to the fluid flow delivered to wand 46 via hose 48. It is appreciated that agent introduction system 86 could be configured to introduce such a treatment agent to the feed water stream at a low pressure or a high pressure side of pump 44, prior to delivery of the operating fluid to wand 46, immediately prior to the introduction of the operating fluid stream to nozzle assembly 52 at discharge end 50 of wand 46, and/or downstream of nozzle assembly 52. It is further appreciated that although agent introduction system 86 is shown as being supported proximate engine 42 and pump 44 associated with chassis 54, agent introduction system 86 could be associated with hose 48 and/or supported and/or integrated with wand 46. Regardless of the specific location of agent introduction system 86, each such configuration further increases the functionality of pressure washer 40 whether utilized with nozzle assembly 52 or another nozzle assembly 72-80.

FIGS. 2 and 3 show a nozzle assembly 90 according to one embodiment of the present invention. As described herein below, it is appreciated that each nozzle assembly embodiment according to the present invention be constructed to cooperate with pressure washer 40 as nozzle assembly 52. That is, it is appreciated that nozzle assembly 90 may cooperate with pressure washer 40 via connection with discharge end 50 of wand 46 and/or be supported proximate thereto when not in use such as via cooperation with a respective one of mounting portions 66. It is further appreciated that the interaction of nozzle assembly 90 with wand 46 can be provided in a tooled or tool-less interface as are commonly know. When provided in a tool-less interface, regardless of the operation or modality of the tool-less interface, it is appreciated that such an interface provides a sealed interaction between wand 46 and any nozzle assembly connected thereto.

Still referring to FIGS. 2 and 3, nozzle assembly 90 includes a flow body 92, a control or controller 94, and a shuttle 96. Flow body 92 includes a first end 98 that is shaped cooperate with discharge end 50 of wand 46. Wand 46 includes a hollow passage 100 associated with receiving a working fluid flow 102 from pressure washer 40. Flow body 92 defines a chamber 104 that is shaped to receive shuttle 96 and accommodate translation of shuttle 96 relative thereto.

Shuttle 96 is defined by an elongate body 106 that extends along a longitudinal axis 108. Longitudinal axis 108 is preferably oriented transverse to a longitudinal axis 110 of wand 46. An exterior surface 112 of shuttle 96 includes a plurality of ridges 114, 116, 118, 120, 122, 124 that are disposed about a perimeter of shuttle 96 between a first longitudinal end 126 and a second longitudinal end 128 of body 106. A groove or channel 130, 132, 134, 136 is formed between each of adjacent ridges 114, 116, 118 and adjacent ridges 120, 122, 124 of body 106 of shuttle 96. Channels 130, 132, 134, 136 are each preferably constructed to cooperate with a seal, such as an O-ring, to provide a sealable but slidable interaction between shuttle 96 and chamber 104 of flow body 92. An elongated channel 140 is formed between ridges 118, 120 and provides a working fluid path or working fluid flow 158 communicated between an intake or inlet 142 of flow body 92 and a first orifice 144 and a second orifice 146 associated therewith.

Controller 94 is shaped to rotatable cooperate with flow body 92 and shuttle 96. That is, controller 94 is rotatable relative to flow body 92, shuttle 96, and wand 46. As explained further below, rotation of controller 94 effectuates longitudinal translation of shuttle 96 relative to flow body 92. Controller 94 defines a cavity 150 that is eccentrically oriented relative to axis 110. Shuttle 96 is preferably longer than a radial width of flow body 92 such that ends 126, 128 of shuttle 96 slidably cooperate with an upstanding wall 152 of controller 94 to effectuate longitudinal translation of shuttle 96 along axis 108 relative to flow body 92 during rotation of controller 94 relative to wand 46 and flow body 92.

FIG. 3 shows one orientation of shuttle 96 relative to flow body 92. With respect to the orientation shown in FIG. 3, inlet 142 of flow body 92 is fluidly connected to orifice 144 via channel 140 whereas orifice 146 is fluidly isolated from a working fluid flow path or working fluid flow 158 when shuttle 96 is in the orientation shown in FIG. 3 relative to flow body 92 via interaction with ridge 122 and its relative position between seal receiving channels 134, 136. Rotation of controller 94 relative to flow body 92 effectuates longitudinal translation of shuttle 96 relative to flow body 92 in direction 160 such that second orifice 146 can be fluidly connected to channel 140 and orifice 144 is currently isolated therefrom via interaction of orifice 144 with ridge 116 and its being positioned between seen receiving channels 130, 132. Such an orientation directs working fluid flow 158 through second orifice 146 in a manner that concurrently isolates first orifice 144 from the fluid flow associated with elongated channel 140.

First orifice 144 and second orifice 146 preferably have different shaped or sized openings 162, 164 such that working fluid flow 158 exits nozzle assembly 90 in different flow patterns as a function of which orifice 144, 146 is fluidly exposed to working fluid flow 158. First orifice 144 and second orifice 146 may be formed by flow body 92 or may be provided as permanent or replaceable orifice inserts. It is appreciated that replaceable orifice inserts, even if configured as press fit orifices, allows nozzle assembly 90 to be serviced or uniquely configured should one of orifices 144, 146 be damaged or degraded such that such would not negate the functionality of the entirety of nozzle assembly 90. Nozzle assembly 90 allows pressure washer 40 to achieve multiple spray patterns without replacement or re-engagement of alternate nozzle assemblies with discharge end 50 of wand 46.

It is further appreciated that nozzle assembly 90 can generate a venturi or negative pressure condition within nozzle assembly 90 when the nozzle assembly is switched from a first orifice having a smaller diameter or sized opening than an opening associated with a subsequent orifice. As explained further below after the description of the other nozzle assembly embodiments, such a pressure differential can be utilized to initiate or draw a flow of a supplemental material, such as a cleaning or surface treatment agent such as those associated with system 86 (FIG. 1), into the fluid flow stream directed to the respective nozzle assembly thereby further improving the range of application associated with operation of pressure washer 40.

FIGS. 4-7 show various views of a nozzle assembly 180 according to another embodiment of the present invention. As shown in FIGS. 4 and 5, nozzle assembly 180 is also constructed to be connected to discharge end 50 of wand 46. Nozzle assembly 180 includes a flow body 182 that is constructed to engage discharge end 50 of wand 46 and a control or controller 184 that movably cooperates with flow body 182. Unlike controller 94 of nozzle assembly 90, controller 184 of nozzle assembly 180 is constructed to slidably cooperate with flow body 182 to effectuate the usage of alternate orifices associated with nozzle assembly 180.

As shown best in FIGS. 6 and 7, flow body 182 extends in a longitudinal or axial direction, indicated by line 186, between a first end 188 and a second end 190. First end 188 of flow body 182 is constructed to operationally cooperate with discharge end 50 of wand 46 and second end 190 is generally opposite first end 188. Flow body 182 defines a working fluid flow or working fluid flow path 192 that is defined by an inlet 194 associated with discharge end 50 of wand 46, a first outlet 196, and a second outlet 198 wherein the first and second outlets 196, 198 of flow body 182 are positioned nearer second end 190 but extend in an generally outward radial direction relative to the longitudinal axis 186 of flow body 182.

An exterior radial surface 200 of flow body 182 includes a first channel 202 and a second channel 204 that are oriented on opposite sides of outlets 196, 198 relative to a direction aligned with axis 186 of flow body 182. Channels 202, 204 are shaped to receive a seal that slidably and sealingly cooperates with a surface 206 of a cavity 208 defined by controller 184. Flow body 182 includes an elongate channel 210 that is disposed between channel 202 and end 188 of flow body 182. Channel 210 is shaped to slidably cooperate with a stop such as a roll pin 212 that is positionally associated with controller 184. Pin 212 cooperates with channel 210 in a manner that allows limited axial translation of controller 184 along direction 186 relative to flow body 182.

Controller 184 defines a first working fluid flow path 214 and a second working fluid flow path 216 that are each discreetly associated with one of a first orifice 218 and a second orifice 220. Each orifice 218, 220 is defined by or supported by controller 184. It is appreciated that orifices 218, 220 can be permanently attached to controller 184, integrally formed thereby, or provided as a separate structure that removably cooperates with controller 184. Each controller working fluid flow path 214, 216 includes a first portion 222, 224 that extends in a transverse outward radial direction relative to axis 186 of flow body 182 and a second portion 226, 228 that is generally aligned with, but radially offset from, the longitudinal axis 186 of flow body 182.

Flow path 214 includes an inlet 230 that is offset relative to an inlet 232 associated with working fluid flow path 216 with respect to axis 186. Inlets 230, 232 of flow paths 214, 216 are offset from one another relative to axis 186 to allow discrete but selective fluid communication between inlet 194 of flow body 182 and one of inlet 232 associated with fluid flow path 216 and inlet 230 associated with flow path 214 of controller 184. That is, longitudinal translation of controller 184 relative to flow body 182 allows discrete select fluid communication of working fluid flow 192 with one of respective orifices 218, 220 of nozzle assembly 180. Slidable cooperation of controller 184 with flow body 182 and the orientation of outlets 196, 198 between channels 202, 204 maintains fluid isolation of the respective flow path 214, 216 of controller 184 when the inlet 230, 232 associated therewith is not aligned with the corresponding outlet 196, 198 of flow body 182.

With respect to the orientation of controller 184 relative to flow body 182 shown in FIG. 6, outlet 196 of flow body 182 is in fluid communication with inlet 232 of flow path 216 of controller 184 such that the working fluid exits nozzle assembly 180 at only orifice 220. FIG. 7 shows a second orientation of controller 184 relative to flow body 182 wherein controller 184 has been moved in direction 240 relative to flow body 182 with respect to the orientation shown in FIG. 6. As shown in FIG. 7, inlet 232 of controller 184 is fluidly isolated from working fluid flow path 192 of flow body 182 whereas inlet 230 of flow path 214 of controller 184 is fluidly connected to outlet 198 of flow body 182 such that the working fluid flow 192 exits nozzle assembly 180 at orifice 218. Longitudinal translation of controller 184 relative to flow body 182 in directions aligned with axis 186 effectuates the discrete but selective fluid communication of fluid flow path 192 of flow body 182 for alternate use of orifices 218, 220 of nozzle assembly 180 during operation of pressure washer 40. As mentioned above, manipulation of nozzle assembly 180 for use with alternate orifices 218, 220 also creates a pressure differential or venturi associated with creating a negative pressure for drawing soap or other cleaning agents such as from system 86 into the flow stream associated with the usage of nozzle assembly 180 for soaping and non-soaping usages of the same.

FIGS. 8-13 show various views of a nozzle assembly 250 according to another embodiment of the invention. Referring to FIG. 8, nozzle assembly 250 includes a controller 252 that is rotationally connected to a discharge end 50 of wand 46. Controller 252 includes an optional elongate body 254 that extends along a portion of the elongate shaft of wand 46 to form a first optional first handle 256 and/or a second handle 258. Preferably, first and second handles 256, 258 are within an easily reachable distance of an operator engaged with trigger 53 of wand 46. It is appreciated that one and/or both of handles 256, 258 of controller 252 may be rotatable relative to wand 46 to effectuate the desired radial manipulation of controller 252 relative to wand 46.

Nozzle assembly 250 includes an optional cover 260 that is disposed proximate a discharge end 262 of nozzle assembly 250. It is appreciated that cover 260 may be integrally formed controller 252 and/or configured to be removable therefrom as shown. A first orifice 264 and a second orifice 266 are supported by cover 260 and are oriented to be discreetly and selectively connected to a working fluid flow, indicated by arrow 268, associated with fluid communicated through wand 46. As explained further below, manipulation of controller 252 discretely and selectively directs the working fluid to one of respective orifices 264, 266 whereat the fluid flow is directed to atmosphere.

Referring to FIG. 9, a flow body 270 is connected to discharge end 50 of wand 46 and is generally disposed with a cavity 274 defined by the cooperation of controller 252 and cover 260. Flow body 270 is constructed to communicate the working fluid flow through the flow body and to a respective orifice 264, 266 (FIG. 8). Controller 252 defines cavity 274 such that cavity 274 is shaped to accommodate the rotational interaction of controller 252 with flow body 270.

Referring to FIGS. 10-12, a fastener 280 passes through an opening 282 associated with cover 260 when threadably engaged with a recess 284 defined by flow body 270. It is appreciated that various other means exist for connecting controller 252 and cover 260 relative to flow body 270. Recess 284 is preferably centrally disposed with respect to a pivot 286 that is defined by flow body 270. Flow body 270 includes a discharge opening or outlet 288 that is radially offset from an axis 290 associated with pivot 286. Axis 290 is preferably coaxial with a longitudinal axis of wand 46. An index assembly 292 is also radially offset relative to axis 290 and is preferably oriented in an opposite direction relative to outlet 288 of flow body 270. As explained further below, rotation of controller 252 relative to flow body 270 about axis 290 associated with pivot 286 effectuates discrete selective fluid communication of outlet 288 of flow body 270 with one of orifices 264, 266.

Referring to FIGS. 10 and 11, indexer assembly 292 includes a ball 294 that is constructed to translatably cooperate with a first recess 296 and a second recess 298 formed on an underside 300 of cover 260. Recesses 296, 298 are preferably offset in an outward radial direction relative to opening 282 and disposed on a generally opposite lateral side of cover 260 relative to the orientation of orifices 264, 266.

Referring to FIG. 11, it should be appreciated that ball, axis 290, and outlet 288 are aligned along a common lateral axis associated with the plane that contains axis 290. Referring to FIG. 12, recess 296, an axis associated with opening 282, and orifice 264 are aligned along a first comment axis whereas recess 298, the axis associated with opening 282, and orifice 266 are oriented along a second comment axis that is at an angled orientation relative to a centerline that extends through both of recess 296 and orifice 264. Rotation of controller 252 relative to axis 290 effectuates operational alignment of only one of orifice 264 and orifice 266 with outlet 288 of flow body 270 at any given instance.

Unlike the flow bodies of nozzle assembly 90 and nozzle assembly 180, flow body 270 includes a singular flow path that communicates fluid flow from wand 46 to outlet 288. Manipulation of the orientation of controller 252 relative to flow body 270 effectuates a desired alignment of one of orifices 264, 266 with outlet 288. The cooperation of ball 294 with recesses 296, 298 provides a tactile and/or audible indication of the desired orientation of the respective orifice 264, 266 relative to outlet 288 of flow body 270. The cooperation of ball 294 with a respective recess 296, 298 also reduces or prevents instances of unwanted translation of controller 252 relative to flow body 270.

Referring to FIG. 13, as alluded to above, flow body 270 includes an inlet 302 that is in fluid communication with an outlet 304 associated with discharge end 50 of wand 46 and communicates a working fluid flow 306 from wand 46 to a working fluid flow path 308 defined by flow body 270. Outlet 288 associated with flow path 308 is offset in an outward radial direction relative to axis 290 associated with rotation of controller 252 relative to flow body 270. Flow body 270 includes a cavity 310 that is fluidly isolated from working fluid flow path 308. Cavity 310 is shaped cooperate with indexer assembly 292 and preferably includes a biasing means, such as a spring 312, associated with biasing ball 294 into underside 300 of cover 260 for cooperation with a respective recess 296, 298 associated therewith. Rotation of controller 252 about axis 290 relative to flow body 270 allows flow path 308 of flow body 270 to achieve the desired operational association of flow path 308 of flow body 270 with a respective orifice 264, 266 while concurrently isolating the other orifice 264, 266 from the working fluid associated with flow path 308.

It should be appreciated that each of nozzle assemblies 90, 180, 250 include multiple orifices that are associated with facilitating different spray conditions associated with each of the respective nozzle assemblies. Understandably, one or more of nozzle assemblies 90, 180, 250 may have one or more similar sized and/or shaped openings associated with the respective orifices. It should further be appreciated that configuring the respective nozzle assemblies between orifice shapes that have smaller and/or respectively larger operating diameters or shapes, a pressure differential can be generated within the confines of each nozzle assembly so as to generate a venturi or vacuum pressure affect associated with the introduction of supplemental materials such as cleaning solutions into the fluid flow stream prior to egress of the working fluid from the respective nozzle assembly, such as via system 86 as described above.

Each of nozzle assemblies 90, 180, 250 is usable for various activities associated with operation of pressure washer 40 and does so in a manner that increases the functionality or usability of pressure washer 40 for various different washing and/or cleaning tasks. Each nozzle assembly 90, 180, 250 being provided with more than one orifice allows the user to quickly and conveniently manipulate the configuration of the respective nozzle assembly for a desired application without being required to remove or otherwise interfere with the connective association of the respective nozzle assembly with the underlying wand 46. Such configurations allow the user to quickly and conveniently configure pressure washer 40 for alternate uses with limited user interaction and/or configure pressure washer 40 for the desired operation associated with the activity intended to be undertaken. Furthermore, the rotational or axially translatable association of the controller, shuttle, and/or flow body of the respective nozzle assemblies 90, 180, 250 allows for the user to quickly and expeditiously manipulate the respective nozzle assembly for the desired activity and in a manner that provides a robust and resilient cooperation between the respective movable parts of the respective nozzle assemblies.

Many changes and modifications could be made to the invention without departing from the spirit thereof. The scope of these changes will become apparent from the appended claims.

What we claim is:

1. A pressure washer nozzle assembly comprising:
a flow body constructed to be fluidly connected to a discharge end of a wand;
a plurality of orifices exposed to atmosphere and supported by the flow body, the orifices being selectively fluidly connectable to a fluid path defined by the flow body;
a control body movably associated with the flow body; and
a shuttle supported by the flow body and engaged with the control body such that movement of the control body effectuates longitudinal translation of the shuttle relative to the flow body to selectively fluidly connect the plurality of orifices to the fluid path.

2. The pressure washer nozzle assembly of claim 1 wherein the shuttle is movable between a first position wherein one of the plurality of orifices is fluidly connected to the fluid path and another of the plurality of orifices is isolated from the fluid path and a second position wherein the one of the plurality of orifices is isolated from the fluid path and the another of the plurality of orifices is fluidly connected to the fluid path.

3. The pressure washer nozzle assembly of claim 1 wherein the control body is rotatable relative to a wand, the flow body, and the shuttle and the shuttle is slidable relative to the flow body.

4. The pressure washer nozzle assembly of claim 1 wherein the shuttle is defined by a longitudinal axis that extends in a direction that is transverse to a longitudinal axis of a wand and is aligned with a direction of the longitudinal translation.

5. The pressure washer nozzle assembly of claim 1 wherein the shuttle includes at least one groove, a first ridge containing a seal that selectively seals one of the plurality of orifices, and a second ridge containing a seal that selectively seals another of the plurality of orifices as a function of a position of the shuttle relative to the flow body.

6. The pressure washer nozzle assembly of claim 5 wherein the at least one groove is disposed between the first ridge and the second ridge and fluidly communicates with the one and another of the plurality of orifices as a function of the position of the shuttle relative to the flow body.

7. The pressure washer nozzle assembly of claim 1 wherein the control body cooperates with opposite longitudinal ends of the shuttle.

8. A pressure washer nozzle assembly comprising:
a flow body that defines a flow body fluid path constructed to receive a fluid flow from a discharge end of a wand; and
a controller engaged with the flow body, the controller defining a first discharge fluid path associated with a first orifice and a second discharge fluid path associated with a second orifice, the first and the second orifices being radially offset from an axis of the flow body and the controller being axially slidable relative to the flow body to selectively fluidly connect the first discharge fluid path and the second discharge fluid path to the flow body fluid path.

9. The pressure washer nozzle assembly of claim 8 wherein the flow body includes a first discharge opening and a second discharge opening that are aligned with one another along a longitudinal length of the flow body.

10. The pressure washer nozzle assembly of claim 9 wherein the first discharge fluid path and the second discharge fluid path defined by the controller each include an inlet wherein the inlet of the first discharge fluid path is offset longitudinally relative to the inlet of the second discharge fluid path with respect to a longitudinal axis of the controller.

11. The pressure washer nozzle assembly of claim 9 further comprising a first seal and a second seal that are disposed on opposite sides of the first and second discharge openings of the flow body.

12. The pressure washer nozzle assembly of claim 8 further comprising a stop engaged with the controller and which overlaps a portion of the flow body to interfere with removal of the controller therefrom.

13. The pressure washer nozzle assembly of claim 8 wherein at least one of the first orifice and the second orifice removably cooperate with the controller.

14. The pressure washer nozzle assembly of claim 8 wherein a first portion of each of the first and second discharge fluid paths extend in opposite outward radial directions relative to the axis of the flow body and a second portion of each of the first and second discharge fluid paths extend in a direction that is aligned with the axis of the flow body but radially offset therefrom.

15. A pressure washer nozzle assembly comprising:
a flow body constructed to be secured to a discharge end of a wand and defining a flow body flow path therethrough;
a pivot defined by the flow body;
a controller engaged with the pivot to be rotatable relative to the flow body; and
a first orifice and a second orifice associated with the controller and radially offset from an axis of rotation of the controller, the controller being rotatable about the pivot between a first position wherein the first orifice is fluidly connected from the flow body flow path and the second orifice is positionally offset from the flow body flow path and a second position wherein the first orifice is positionally offset from the flow body flow path and the second orifice is fluidly connected to the flow body flow path.

16. The pressure washer nozzle assembly of claim 15 further comprising an indexer that selectively maintains a relative position of the controller relative to the flow body.

17. The pressure washer nozzle assembly of claim 16 wherein the indexer further comprises a ball that is biased into engagement with the controller.

18. The pressure washer nozzle assembly of claim 16 wherein the controller includes a first recess and a second recess that are positioned to respectively cooperate with the indexer when the controller is the first position and the second position.

19. The pressure washer nozzle assembly of claim 16 wherein an outlet defined by the flow body and the indexer are on opposite radial sides of flow body with respect to the pivot.

20. The pressure washer nozzle assembly of claim 15 wherein an axis of rotation of the controller and a longitudinal axis of the wand are coaxial.
